(19) United States
(12) Patent Application Publication
(10) Pub. No.: US 2008/0168931 A1
(43) Pub. Date: Jul. 17, 2008

(54) FURNITURE

(76) Inventor: Wen-Tsan Wang, Taipei City (TW)

Correspondence Address: LEONG C LEI, PMB # 1008, 1867 YGNACIO VALLEY ROAD, WALNUT CREEK, CA, 94598, US

(21) Appl. No.: 11/623,758

(22) Filed: Jan. 17, 2007

(51) Int. Cl. A47B 13/02; B44F 9/02; A47C 7/02; F16M 13/00

(52) U.S. Cl. 108/157.1; 52/313; 297/452.48; 248/158

(57) ABSTRACT

Disclosed is a furniture, which includes a top frame, a bottom frame, endless inner supporting frames spaced between the top frame and the bottom frame, a plurality of strip members arranged around and supported on the periphery of the endless inner supporting frame each having a top end fastened to an endless bottom mounting groove on the bottom side of the top frame and a bottom end fastened to an endless top mounting groove on the top side of the bottom frame, and cord members that secure the strip members to the endless inner supporting frames.

### BACKGROUND OF THE INVENTION

(a) Technical Field of the Invention

The present invention to furniture and more particularly to such a furniture that has its body formed of strips members.

(b) Description of the Prior Art

Many materials including stones, glass, wood, plastics, stainless steel, and etc., are used to make tables, chairs, cabinets and many other different furniture. A wooden furniture shows an antique sense of beauty that attracts people to buy. There are known furniture having a meshed body structure and a framework supporting the meshed body structure. The meshed body structure is formed of wooden or bamboo strips by means of a weaving technique and then bonded or nailed to the framework. The wearing procedure is complicated, requiring much labor and time. Therefore, these conventional meshed body structure type furniture are commonly expensive.

### SUMMARY OF THE INVENTION

The primary purpose of the present invention is to provide furniture which comprises a top frame, which has an endless mounting groove on the bottom side along the border, a bottom frame, which has an endless mounting groove on the top side along the border, at least one endless inner supporting frame spaced between the top frame and the bottom frame, a plurality of strip members that are respectively connected between the top frame and the bottom frame and extending around and supported on the at least one endless inner supporting frame and respectively fastened with the respective top and bottom ends to the endless mounting groove of the top frame and the endless mounting groove of the bottom frame, and at least one fastening member that secures the strip members to the at least one endless inner supporting frame.

According to another aspect of the present invention, the at least one endless inner supporting frame can be made having an outer diameter greater than the top and bottom frames to support the strip members in an outwardly curved status. Alternatively, the at least one endless inner supporting frame can be made having an outer diameter smaller than the top and bottom frames to support the strip members in an inwardly curved status.

According to still another aspect of the present invention, the top and bottom frame and the at least one endless inner supporting frame can be made having a circular or rectangular profile, or any of a variety of shapes.

According to still another aspect of the present invention, a tabletop may be mounted on the top frame so that the furniture is used as a table. Alternatively, a seat or top cover may be provided at the top frame so that the furniture can be used as a chair or storage container.

According to still another aspect of the present invention, the at least one fastening member each can be a cord member.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a furniture in accordance with one embodiment of the present invention.

FIG. 2 is a sectional view taken along line A-A of FIG. 1.

FIG. 3 is similar to FIG. 2 by showing a wave-like shape of the strip members.

FIG. 4 corresponds to FIG. 3, showing a seat cushion attached to the top side of the top frame.

FIG. 5 is a sectional view corresponding to FIG. 2, showing the connection structure between the top and bottom frames and the strip members.

FIG. 6 is similar to FIG. 5 but showing the strip members curved inwards.

FIG. 7 is a sectional assembly view corresponding to the embodiment of FIG. 6.

FIG. 8 illustrates the strip members connected between the top frame and the bottom frame and curved inwards and a seat cushion supported on the top frame.

FIG. 9 illustrates furniture with a seat back according to the present invention.

FIG. 10 is a sectional view showing the connection arrangement between the top and bottom frames and straight strips according to the present invention.

FIG. 11 is an elevational view of a cylindrical basket constructed according to the present invention.

FIG. 12 illustrates a storage container with arched strip members according to the present invention.

FIG. 13 illustrates a storage container with straight strip members according to the present invention.

FIG. 14 illustrates a peanut-shaped endless supporting frame for a furniture according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

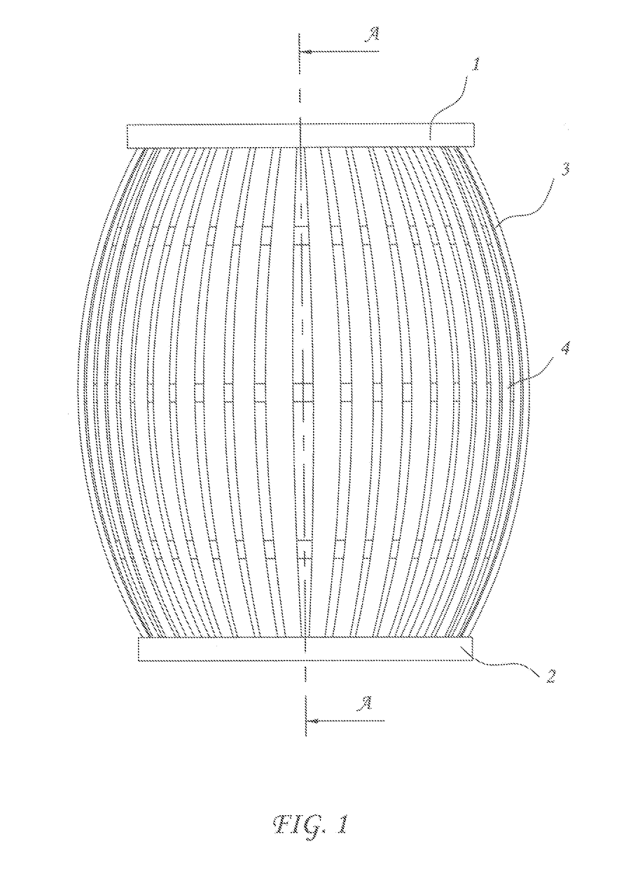

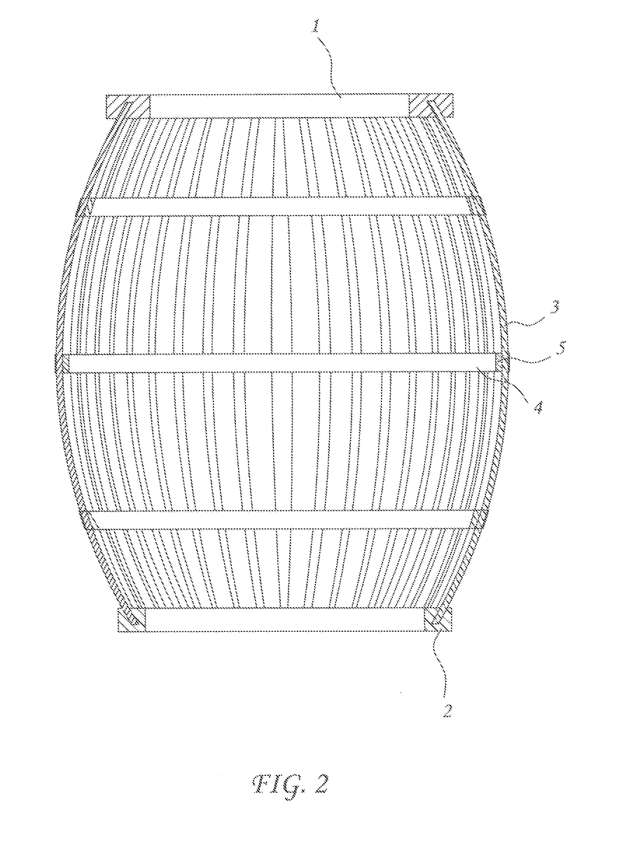

Referring to FIGS. 1 and 2, a furniture in accordance with the present invention is shown comprising a top frame 1, a bottom frame 2, a plurality of strip members (for example, wooden strips or bamboo strips) 3 connected between the top frame 1 and the bottom frame 2 to hold the top frame 1 and the bottom frame 2 horizontally in parallel, a plurality of endless inner supporting frames 5 attached to the inner surface of each of the strip members 3 at different elevations between the top frame 1 and the bottom frame 2, and fastening members, for example, cord members 4 that secure the strip members 3 to the endless inner supporting frames 5. The top frame 1 can be a circular or rectangular open frame, or nay other profiles. The bottom frame 2 can be a circular or rectangular open frame, or any other profiles.

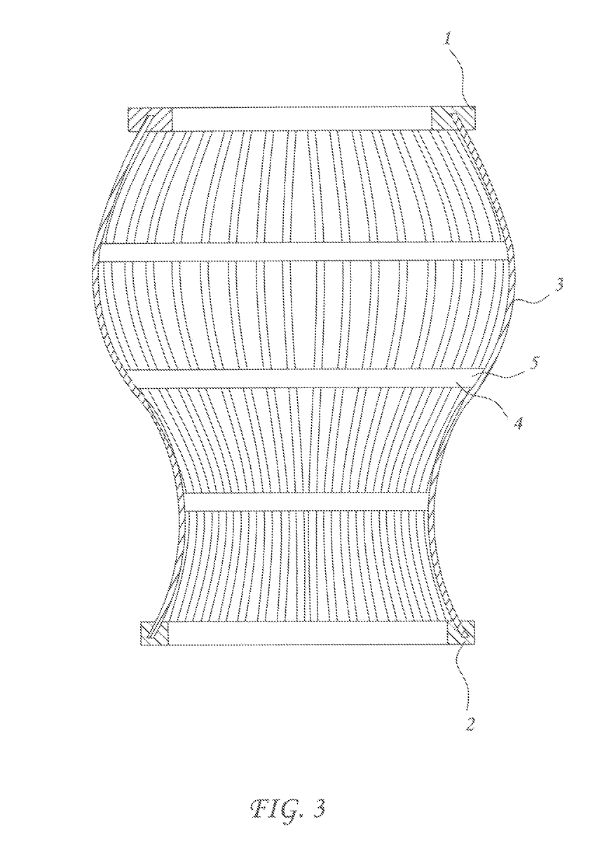

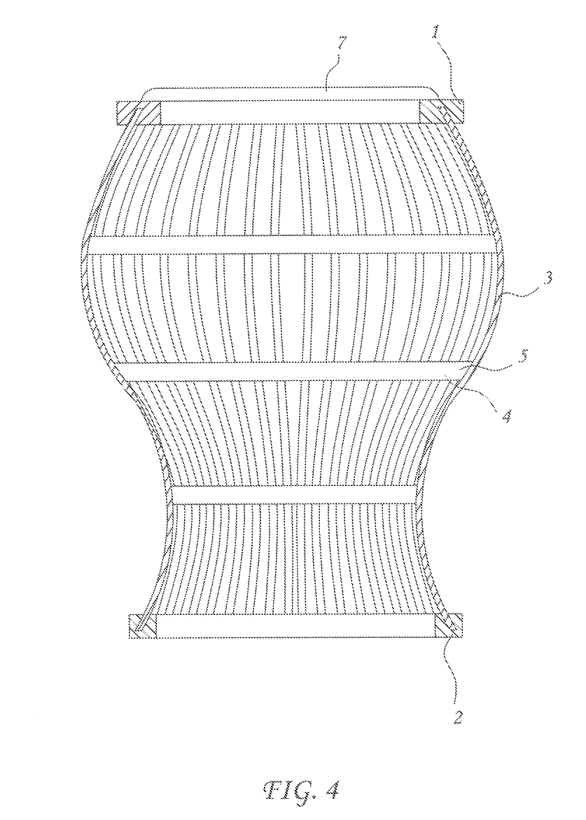

The strip members 3 can be curved to shown an arched shape (see FIG. 1 and 2) or wave-like shape (see FIGS. 3 and 4).

Referring to FIG. 4, a seat cushion 7 may be attached to the top side of the top frame 1 for sitting. Alternatively, a tabletop may be attached to the top side of the top frame 1 so that the furniture is used as a table.

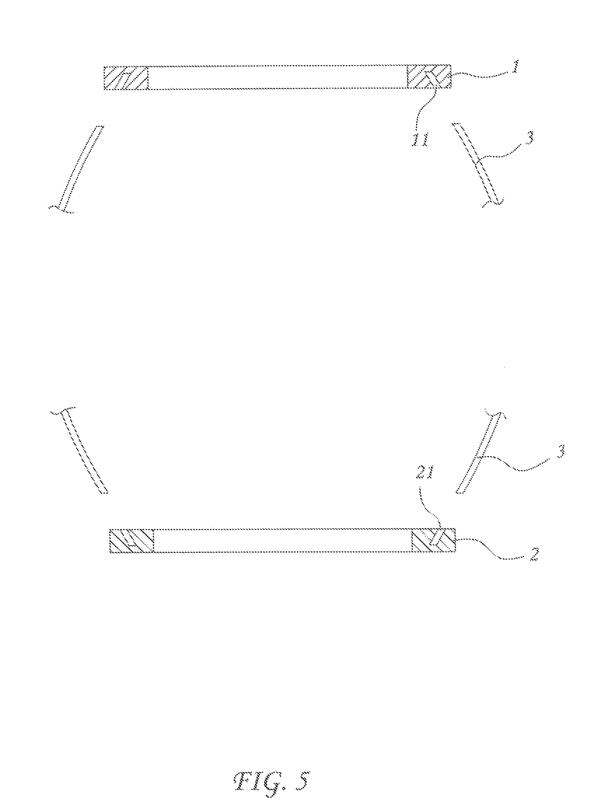

Referring to FIG. 5, the top frame 1 and the bottom frame 2 each have an endless mounting groove 11 or 21 on the bottom or top side around the border. The endless mounting groove 11 or 21 has a cross section sloping in one direction. The strip members 3 each have a top end respectively inserted into the endless mounting groove 11 on the top frame 1 and a bottom end respectively inserted into the endless mounting groove 21 on the bottom frame 2. Further, a table board may be supported on the top frame 1 so that the furniture can be used as a table. After removal of the table board, the furniture is used as a storage container for keeping things.

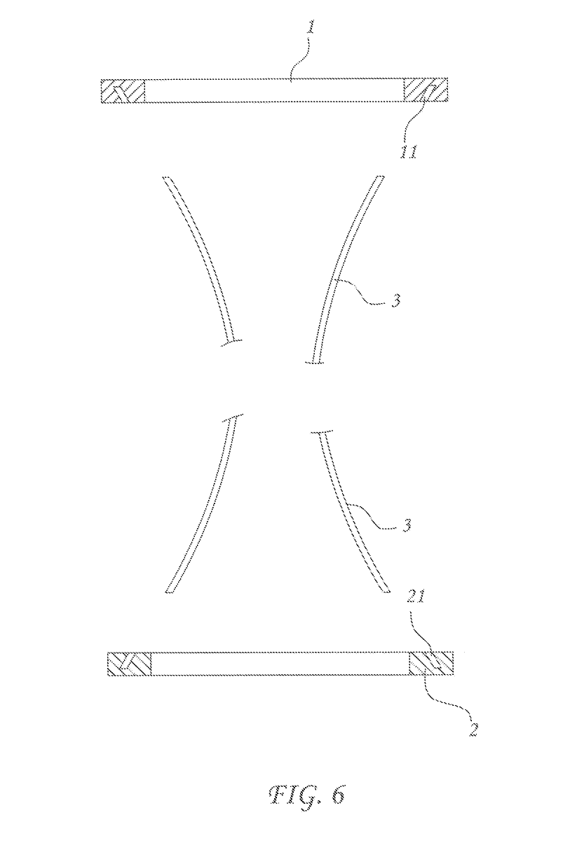

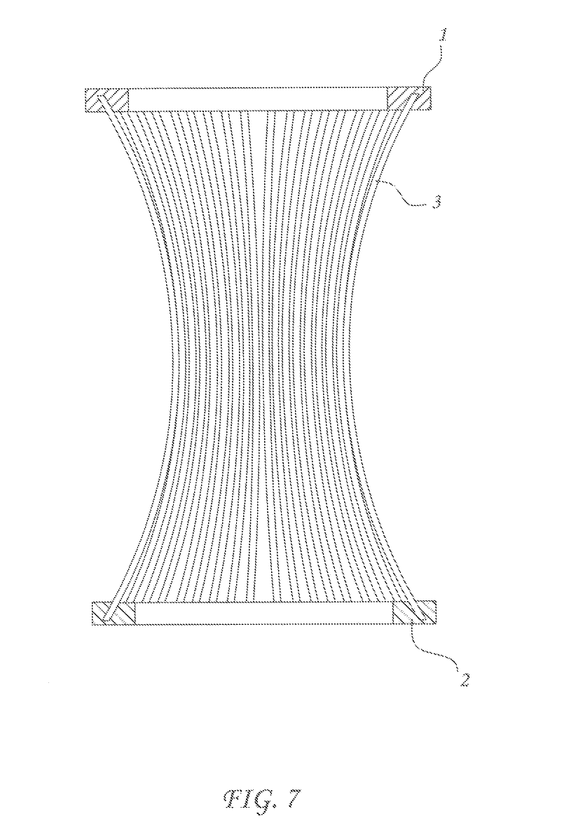

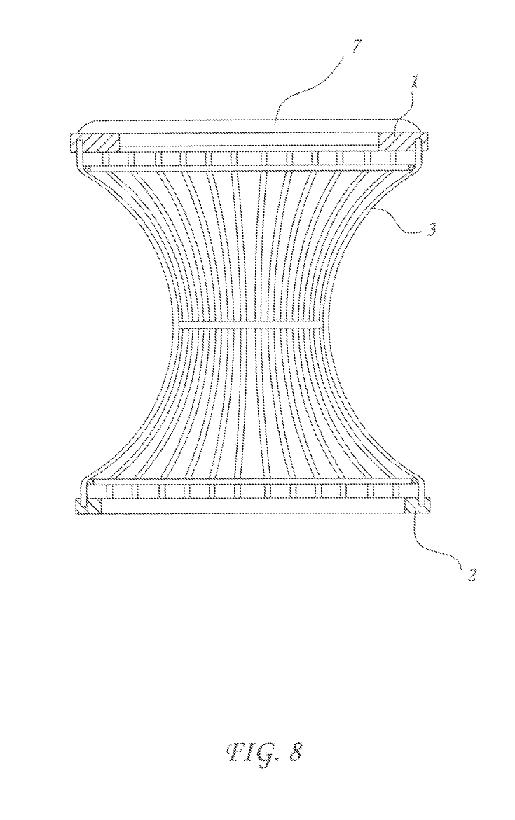

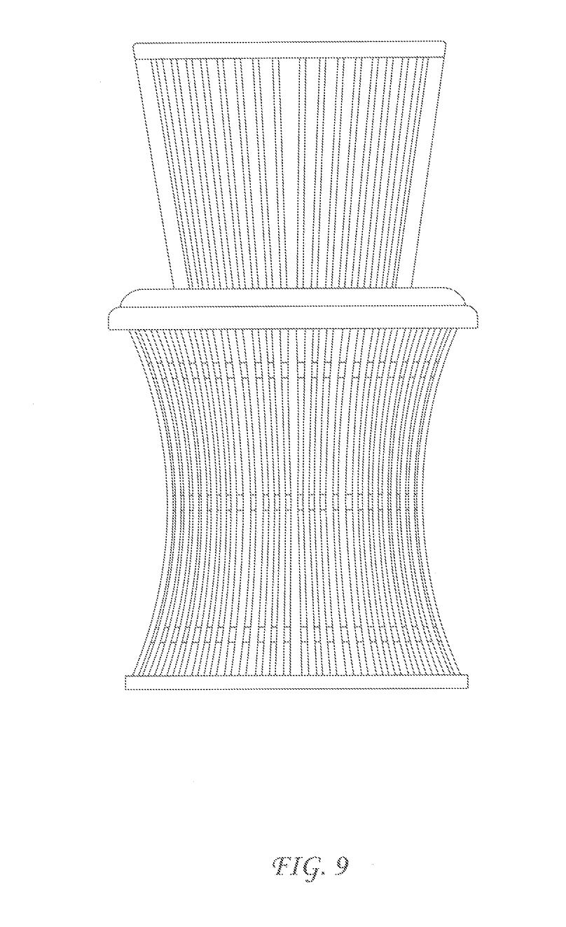

The arched strip members 3 may be connected between the top frame 1 and the bottom frame 2 and respectively curved outwards, as shown in FIGS. 1, 2 and 5. Alternatively, the arched strip members 3 may be connected between the top frame 1 and the bottom frame 2 and respectively curved inwards, as shown in FIGS. 6, 7 and 8. In FIG. 8, a seat cushion 7 is attached to the top side of the top frame 1 so that the furniture is used as a seat. Further, a seat back may be provided at the top frame of the furniture to support the back of the person sitting on the seat cushion (see FIG. 9).

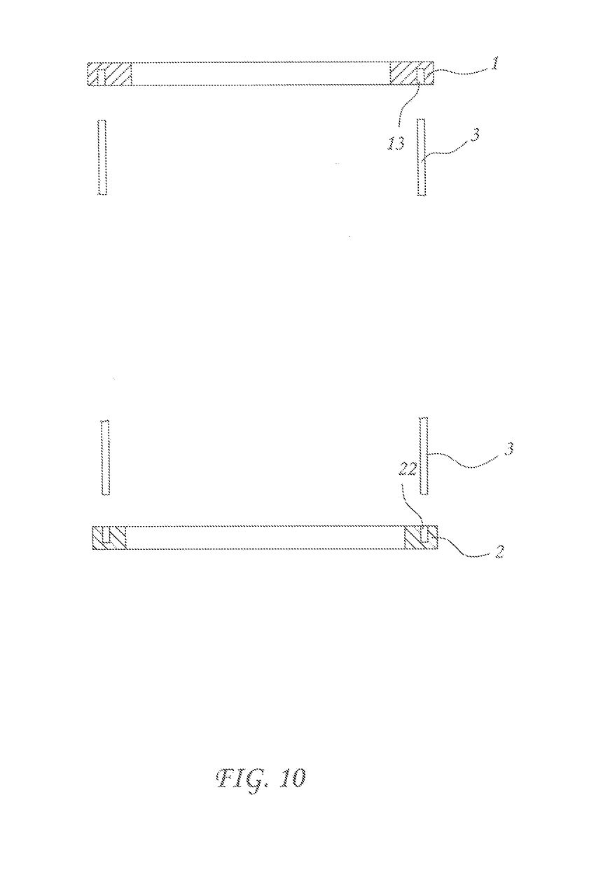

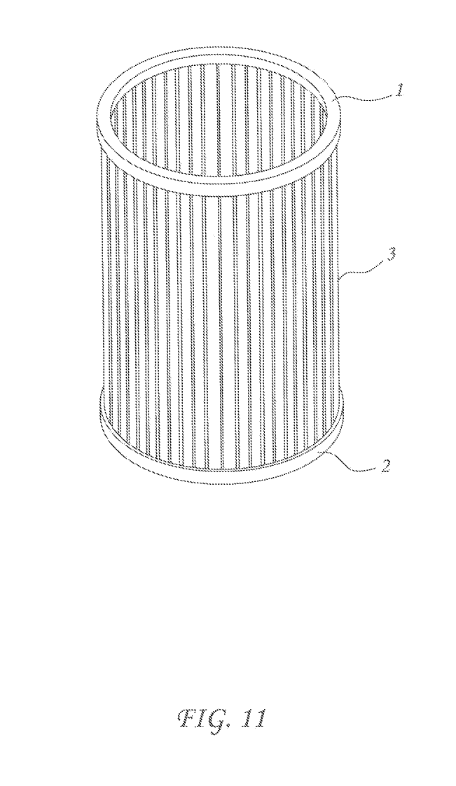

Referring to FIG. 10, the top frame 1 and the bottom frame 2 each have an endless mounting groove 13 or 22 on the bottom or top side around the border. The endless mounting groove 11 or 21 has a straight cross section. The strip members 3 can be straight strip members each having a top end respectively inserted into a respective endless mounting groove 13 on the bottom side of the top frame 1 and a bottom end respectively inserted into a respective endless mounting groove 22 on the top side of the bottom frame 2, thereby forming a cylindrical basket (see FIG. 11).

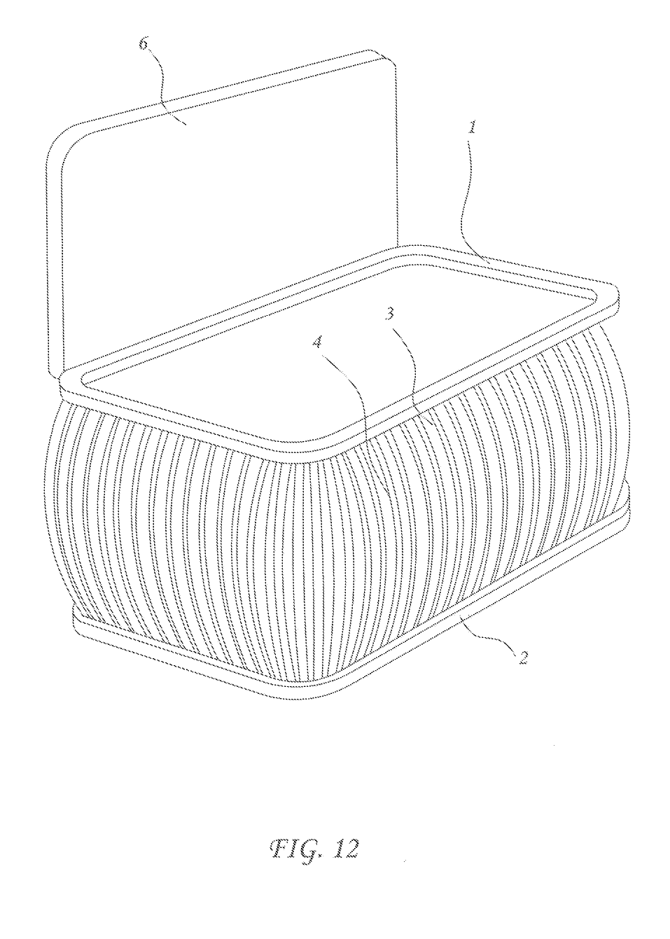

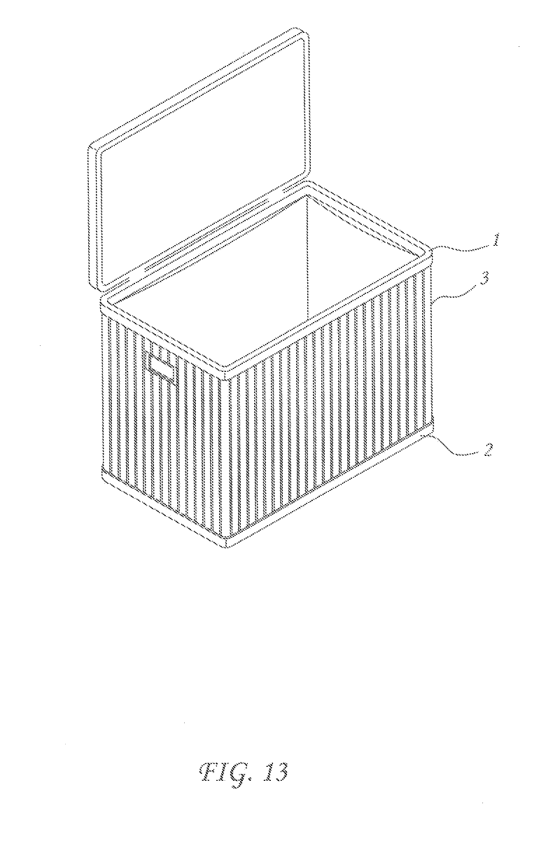

Referring to FIGS. 12 and 13, the strip members 3 are connected between the top frame 1 and the bottom frame 2, and cord members 4 are fastened to the strip members 3 to affix the endless inner supporting frames (not shown) to the strip members, and a top cover 6 is hinged to the top frame 1 for closing the opening of the top frame 1, and therefore the furniture is used as storage container.

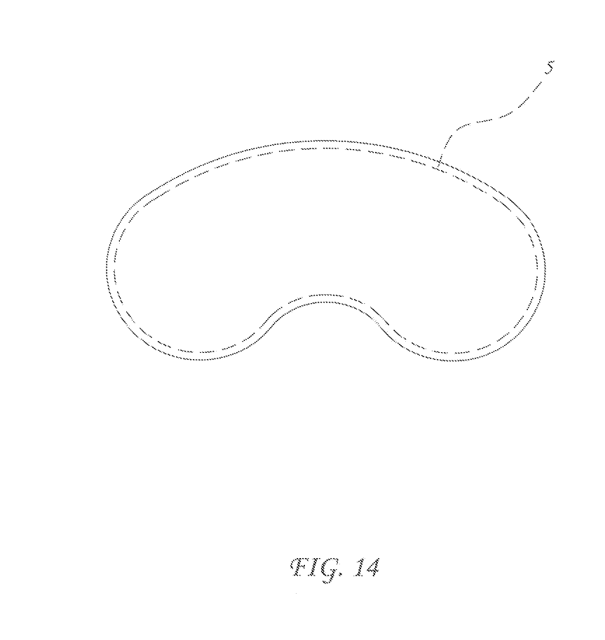

Referring to FIG. 14 the endless inner supporting frame 5 can be made having a contour shaped like a peanut. In this case, the top frame and the bottom frame can be made having the same profile.

A prototype of furniture has been constructed with the features of FIGS. 1-14. The furniture functions smoothly to provide all of the features disclosed earlier.

Although particular embodiments of the invention have been described in detail for purposes of illustration, various modifications and enhancements may be made without departing from the spirit and scope of the invention. For example, straight strip members may be used and connected between the top frame and the bottom frame to substitute for the arched strip members. Accordingly, the invention is not to be limited except as by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A furniture comprising:
a top frame, said top frame having an endless mounting groove on a bottom side along the border thereof;
a bottom frame, said bottom frame having an endless mounting groove on a top side along the border thereof;
at least one endless inner supporting frame spaced between said top frame and said bottom frame;
a plurality a strip members respectively connected between said top frame and said bottom frame and extending around and supported on said at least one endless inner supporting frame, said strip members each having a top end respectively fastened to the endless mounting groove of said top frame and a bottom end respectively fastened to the endless mounting groove of said bottom frame; and
at least one fastening member that secures said strip members to said at least one endless inner supporting frame.

2. The furniture as claimed in claim 1, wherein said at least one endless inner supporting frame each have an outer diameter greater than said top frame and said bottom frame; the endless mounting grooves of said top frame and said bottom frame have a vertical cross section extending obliquely from an outer side toward an inner side.

3. The furniture as claimed in claim 1, wherein said at least one endless inner supporting frame each have an outer diameter smaller than said top frame and said bottom frame; the endless mounting grooves of said top frame and said bottom frame have a vertical cross section extending obliquely from an inner side toward an outer side.

4. The furniture as claimed in claim 1, wherein said at least one endless inner supporting frame each have an outer diameter equal to said top frame and said bottom frame; the endless mounting grooves of said top frame and said bottom frame have a straight vertical cross section.

5. The furniture as claimed in claim 1, wherein said top frame and said bottom frames have different shapes.

6. The furniture as claimed in claim 1, further comprising a tabletop mounted on said top frame.

7. The furniture as claimed in claim 1, further comprising a seat cushion mounted on said top frame.

8. The furniture as claimed in claim 7, further comprising a seat back fastened to said top frame at one side of said seat cushion.

9. The furniture as claimed in claim 1, further comprising a top cover for covering said top frame.

10. The furniture as claimed in claim 1, wherein said strip members are wooden strips.

11. The furniture as claimed in claim 1, wherein said strip members are bamboo strips.
